(19) United States
(12) Patent Application Publication
(10) Pub. No.: US 2012/0308147 A1
(43) Pub. Date: Dec. 6, 2012

(54) IMAGE PROCESSING DEVICE, IMAGE PROCESSING METHOD, AND PROGRAM

(75) Inventors: Hiroshi IKEDA, Kanagawa (JP); Takahiro Sato, Tokyo (JP); Kazuhiro Shimauchi, Tokyo (JP); Yuji Wada, Tokyo (JP)

(73) Assignee: SONY CORPORATION, Tokyo (JP)

(21) Appl. No.: 13/440,395

(22) Filed: Apr. 5, 2012

(30) Foreign Application Priority Data
May 30, 2011 (JP) 2011-120239

(51) Int. Cl. G06K 9/36

(52) U.S. Cl. 382/233

(57) ABSTRACT

There is provided an image processing device including a selection section which selects an image from a plurality of images each having resolution different from each other and being capable of being partially decoded, based on a ratio of a size of a display target area to a size of a reference image among the plurality of images, and a decoding section which decodes a part corresponding to the display target area within the image selected by the selection section.

### BACKGROUND

The present disclosure relates to an image processing device, an image processing method, and a program.

In recent years, there have been developed various types of image encoding technology. When an image is used, it is not that the whole image is used at all times, and there is also a case where a part of the image is used. In this case, the whole encoded image may not be decoded, and the decoding may be partially performed for a desired area of the encoded image. Technology related to the partial decoding performed to the encoded image is being variously developed.

For example, in the case where an RSTm (restart marker) is inserted into a JPEG (Joint Photographic Experts Group) stream and an address to the RSTm is recorded in a JPEG file, there is technology involving performing fast partial decoding from the JPEG stream by using the recorded address (for example, refer to JP 3108283B).

### SUMMARY

However, in the case where a relatively small area of an encoded image is displayed, since an area to be decoded (hereinafter, also referred to as “decoding area”) is relatively small, it is assumed that the throughput necessary for the decoding is relatively small. Accordingly, in this case, since the decoding area can be decoded in a relatively short period of time, the decoded image obtained by the decoding can be displayed quickly.

On the other hand, in the case where a relatively large area of the encoded image is displayed, since the decoding area is relatively large, it is assumed that the throughput necessary for the decoding is relatively large. Accordingly, in this case, since it necessitates a relatively long period of time for decoding the decoding area, it is difficult to quickly display the decoded image obtained by the decoding.

In this way, the throughput necessary for decoding generally varies depending on the size of the decoding area. For ensuring the display of any area within an image, it is necessary to ensure that the area can be displayed even in the case where the decoding area is maximum, for example (in the case where the throughput is maximum). Accordingly, in the case where the decoding area is maximum, it takes a long period of time for displaying the decoding area unless a high-performance decoder or the like is used.

In addition, the traffic of the image to be decoded to the decoder is proportional to the size of the decoding area, and thus, in the case where the whole image is to be decoded for example, it is necessary that the whole image be transferred to the decoder, and the load on the bus used for the transfer and the capacity of the storage device used for storing the decoded image also increase.

In light of the foregoing, it is desirable to provide a technique capable of quickly displaying a part corresponding to a display target area within an encoded image, regardless of the size of the display target area.

According to an embodiment of the present disclosure, there is provided an image processing device which includes a selection section which selects an image from a plurality of images each having resolution different from each other and being capable of being partially decoded, based on a ratio of a size of a display target area to a size of a reference image among the plurality of images, and a decoding section which decodes a part corresponding to the display target area within the image selected by the selection section.

According to another embodiment of the present disclosure, there is provided an image processing method which includes selecting an image from a plurality of images each having resolution different from each other and being capable of being partially decoded, based on a ratio of a size of a display target area to a size of a reference image among the plurality of images, and decoding a part corresponding to the display target area within the selected image.

According to another embodiment of the present disclosure, there is provided a program for causing a computer to function as an image processing device including a selection section which selects an image from a plurality of images each having resolution different from each other and being capable of being partially decoded, based on a ratio of a size of a display target area to a size of a reference image among the plurality of images, and a decoding section which decodes a part corresponding to the display target area within the image selected by the selection section.

According to the embodiments of the present disclosure described above, the part corresponding to the display target area within the encoded image can be quickly displayed regardless of the size of the display target area.

### BRIEF DESCRIPTION OF THE DRAWINGS

FIG. 1 is a block diagram showing an example of a configuration of an image processing device according to a comparative example;

FIG. 2 is a diagram showing an example of a format of a file including an input image decoded by the image processing device according to the comparative example;

FIG. 3 is a diagram illustrating display target area information;

FIG. 4 is a diagram illustrating a function of a decoding section according to the comparative example;

FIG. 5 is a diagram illustrating a function of an adjustment section according to the comparative example;

FIG. 6 is a flowchart showing an example of an operation of the image processing device according to the comparative example;

FIG. 7 is a block diagram showing an example of a configuration of an image processing device according to the present embodiment;

FIG. 8 is a diagram showing an example of a format of a file including input images decoded by the image processing device according to the present embodiment;

FIG. 9 is a diagram illustrating functions of a selection section and a decoding section according to the present embodiment;

FIG. 10 is a diagram illustrating functions of the selection section and the decoding section according to the present embodiment;

FIG. 11 is a diagram illustrating a function of an adjustment section according to the present embodiment;

FIG. 12 is a flowchart showing an example of an operation of the image processing device according to the present embodiment;

FIG. 13 is a flowchart showing another example of the operation of the image processing device according to the present embodiment;

FIG. 14 is a diagram showing an outline of a system configuration in the case where an image processing device and a server perform image processing in cooperation with each other;

FIG. 15 is a diagram showing a specific example 1 of a system configuration diagram;

FIG. 16 is a diagram showing a specific example 2 of the system configuration diagram; and

FIG. 17 is a diagram showing a specific example 3 of the system configuration diagram.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, description will be given in the following order.
1. Comparative example
   1-1. Configuration example of image processing device
   1-2. Flow of operation performed by image processing device
2. Present embodiment
   2-1. Configuration example of image processing device
   2-2. Flow of operation performed by image processing device
3. Conclusion

### 1. COMPARATIVE EXAMPLE

### 1-1. Configuration Example of Image Processing Device

First, an image processing device according to a comparative example will be described. The image processing device according to the comparative example functions mainly as a decoding device for decoding an input image. The image to be decoded by the image processing device according to the comparative example may be a picked-up image, or may be a non-picked-up image such as a computer graphics (CG) image. The image processing device according to the comparative example may be any type of device such as a digital still camera, a smartphone, a personal computer (PC), or an image scanner. Further, the image processing device according to the comparative example may be an image decoding module mounted on the above-mentioned device.

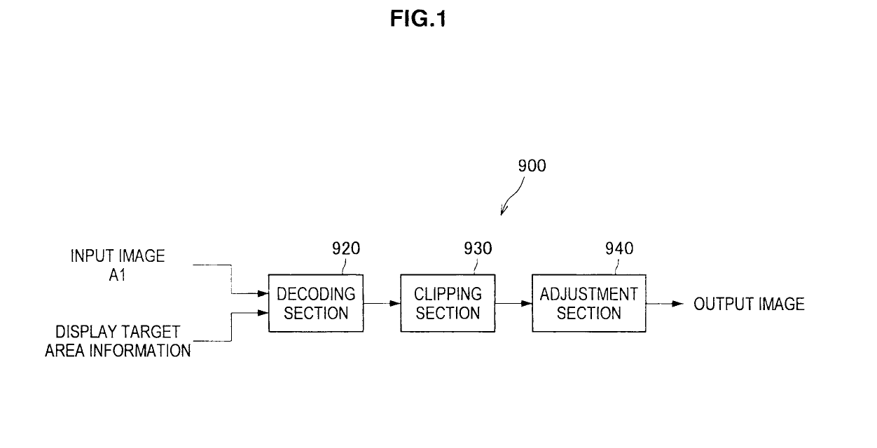

FIG. 1 is a block diagram showing an example of a configuration of an image processing device according to the comparative example. Referring to FIG. 1, an image processing device 900 includes a decoding section 920, a clipping section 930, and an adjustment section 940. Note that only the structural elements related to image processing are shown here for the sake of simple description. However, the image processing device 900 may have structural elements other than the structural elements shown in FIG. 1.

As shown in FIG. 1, the decoding section 920 acquires an input image A1, which is to be decoded, and display target area information, and decodes the input image A1 based on the display target area information. The input image A1 is encoded by an encoding device (not shown), and the encoding system is not particularly limited, and may be variable length coding (VLC) based on a Huffman code, a Golomb code, or the like, or may be entropy coding, for example.

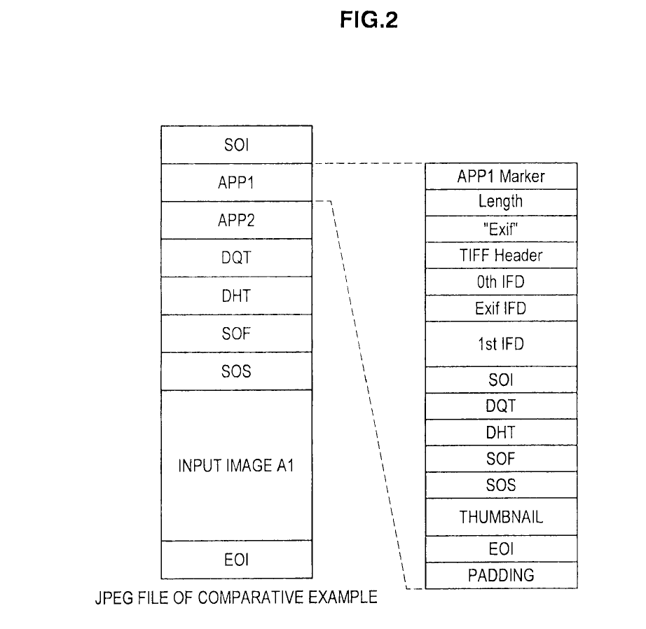

FIG. 2 is a diagram showing an example of a format of a file including the input image A1 to be decoded by the image processing device 900 according to the comparative example. For example, although the input image A1 is given in a format included in the JPEG file shown in FIG. 2, it is not particularly limited as to a file in what format the input image A1 is given.

The decoding section 920 may acquire the input image A1 in any ways. That is, the decoding section 920 may acquire an image picked up by an imaging module (not shown) as the input image A1. Instead, the decoding section 920 may acquire an image recorded in a recording medium (not shown) as the input image A1. In the comparative example, the input image A1 acquired by the decoding section 920 may be a moving image or a still image.

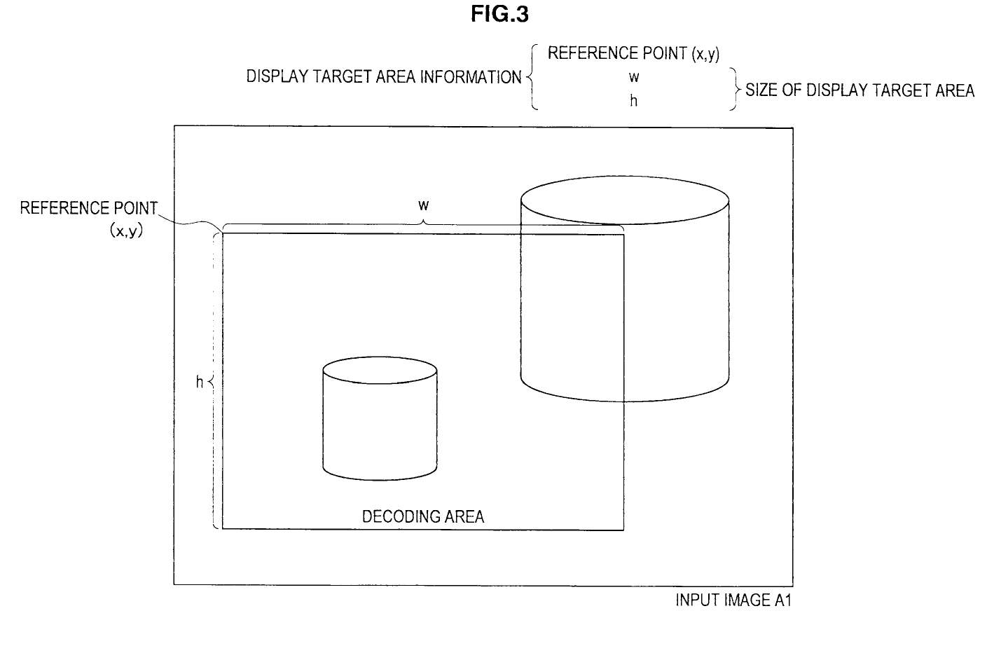

FIG. 3 is a diagram illustrating display target area information. As shown in FIG. 3, the display target area information includes a reference point (x,y), a width w, and a height h, for example. In the example shown in FIG. 3, the reference point (x,y) is defined by coordinates having an origin at a predetermined position (the top-left corner in the example shown in FIG. 3) of the input image A1, but a technique for defining the reference point (x,y) is not particularly limited. The width w and the height h are each represented by the number of pixels, for example.

The decoding section 920 may acquire the display target area information in any ways. That is, the decoding section 920 may acquire display target area information which accepts the input from a user using an input device, for example. Instead, the decoding section 920 may acquire display target area information which is determined in advance from a recording medium (not shown) or the like.

As described above, the decoding section 920 decodes the input image A1 based on the display target area information. In more detail, the decoding section 920 decodes the area defined by the display target area information within the input image A1 as a decoding area. In the example shown in FIG. 3, the decoding area corresponds to a part of the input image A1. That is, the decoding section 920 is capable of executing partial decoding to the input image A1. The technique of partial decoding here is not particularly limited, and any technique can be applied thereto.

For example, in the case where a file including the input image A1 includes an index (information indicating sequentially multiple coordinates in the input image A1 using offsets from the head of the input image A1), the partial decoding to a display target area can be easily performed based on the index. However, the decoding area may correspond to the whole input image A1. In this case, it is not necessary that the decoding section 920 performs the partial decoding to the input image A1, and may decode the whole input image A1.

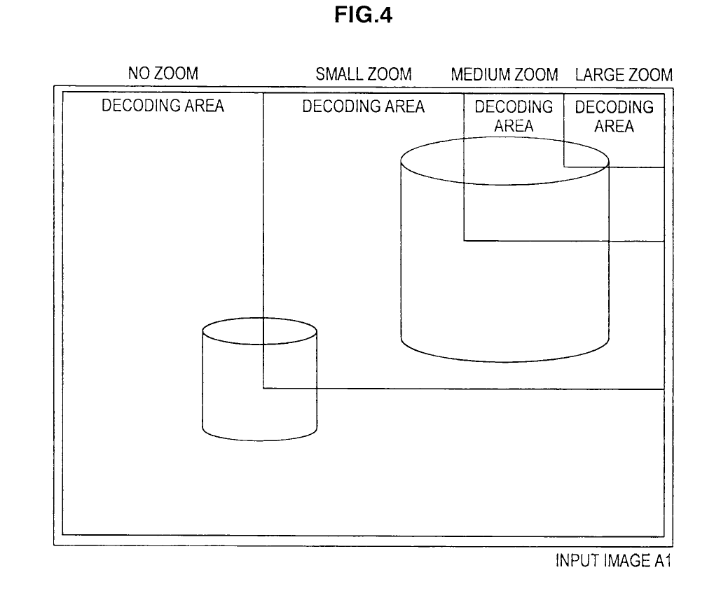

FIG. 4 is a diagram illustrating a function of the decoding section 920 according to the comparative example. As described above, the position and the size of the decoding area may be changed variously in accordance with the display target area information acquired by the decoding section 920. In FIG. 4, a case where the whole input image A1 is the decoding area, a case where a part (relatively large area) of the input image A1 is the decoding area, a case where a part (moderate sized area) of the input image A1 is the decoding area, and a case where a part (relatively small area) of the input image A1 is the decoding area, are represented by “NO ZOOM”, “SMALL ZOOM”, “MEDIUM ZOOM”, and “LARGE ZOOM”, respectively. Note that, although FIG. 4 shows four decoding areas, the number of decoding areas is not limited to four, and may be any as long as it is two or more.

The clipping section 930 clips the decoding area from the image which is obtained by being decoded by the decoding section 920. In more detail, the clipping section 930 clips the area defined by the display target area information from the image which is obtained by being decoded by the decoding section 920. However, it is not necessary that the image processing device 900 be equipped with the clipping section 930, and the image processing device 900 may not be equipped with the clipping section 930.

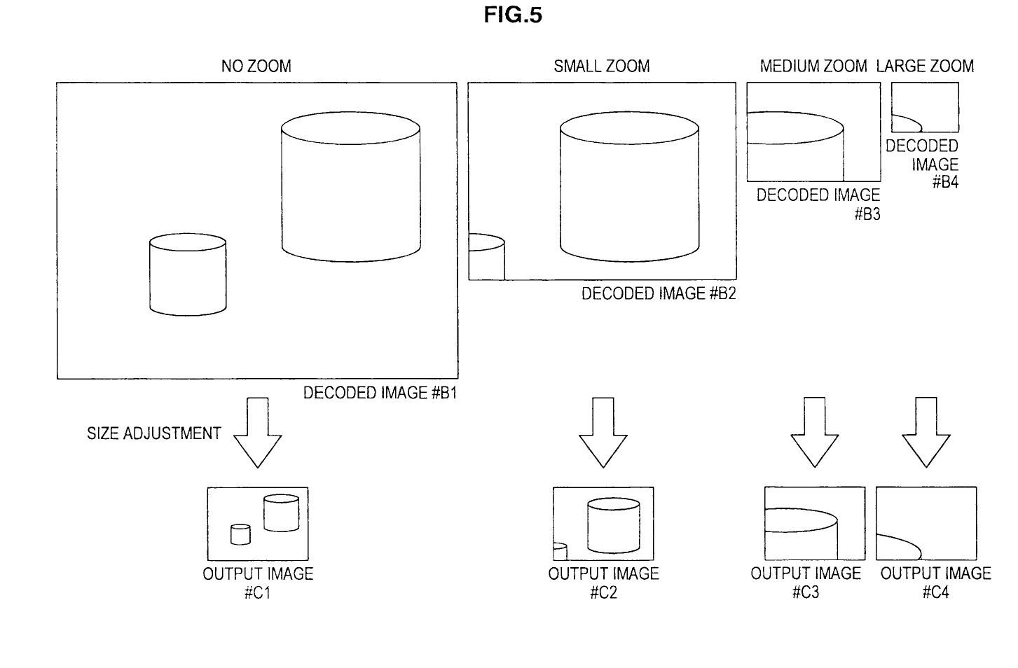

FIG. 5 is a diagram illustrating a function of the adjustment section 940 according to the comparative example. As shown in FIG. 5, a decoded image #B1 is obtained by decoding the whole input image A1. In the same manner, in the case where a part (relatively large area) of the input image A1 is decoded, a decoded image #B2 is obtained, in the case where a part (moderate sized area) of the input image A1 is decoded, a decoded image #B3 is obtained, and in the case where a part (relatively small area) of the input image A1 is decoded, a decoded image #B4 is obtained.

The adjustment section 940 adjusts the size of the part corresponding to the decoding area within the image which is obtained by being decoded by the decoding section 920. As shown in FIG. 5, the adjustment section 940 performs size adjustment (reduction) of the decoded image #B1, thereby obtaining an output image #C1. In the same manner, the adjustment section 940 performs size adjustment (reduction) of the decoded image #B2, thereby obtaining an output image #C2, the adjustment section 940 performs size adjustment (reduction) of the decoded image #B3, thereby obtaining an output image #C3, and the adjustment section 940 performs size adjustment (enlargement) of the decoded image #B4, thereby obtaining an output image #C4.

In this way, the size adjustment may be performed by enlarging or reducing, by the adjustment section 940, the part corresponding to the decoding area within the image which is obtained by being decoded by the decoding section 920. The technique of size adjustment performed by the adjustment section 940 is not particularly limited. For example, in the case where the output image output by the adjustment section 940 is displayed by a display device (not shown), the adjustment section 940 may adjust the size of the part corresponding to the display target area within the image which is obtained by the decoding, in accordance with the size of a display area of the display device (size of a screen of the display device).

### 1-2. Flow of Operation Performed by Image Processing Device

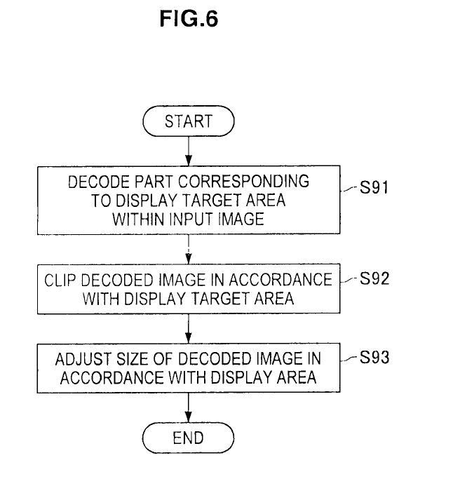

FIG. 6 is a flowchart showing an example of an operation of the image processing device 900 according to the comparative example. First, the decoding section 920 decodes the part corresponding to the display target area within the input image A1 (Step S91). The clipping section 930 clips a decoded image in accordance with the display target area from the image obtained by the decoding (Step S92). However, the clipping by the clipping section 930 may not be performed in particular. Subsequently, the adjustment section 940 adjusts the size of the decoded image in accordance with the display area (Step S93), and completes the operation.

As described above, the image processing device 900 according to the comparative example performs decoding of one input image A1 regardless of the size (width w or height h, or both width w and height h) of the display target area. Accordingly, as shown in FIG. 4, with increase in the size of the display target area, the size of the decoding area increases, and the throughput for the decoding processing and size adjustment increases. Therefore, according to the image processing device 900 of the comparative example, it is difficult to quickly display the part corresponding to the display target area within the encoded image.

### 2. PRESENT EMBODIMENT

### 2-1. Configuration Example of Image Processing Device

Subsequently, an image processing device according to an embodiment of the present disclosure will be described. The image processing device according to the embodiment of the present disclosure exhibits a remarkable effect in comparison with the image processing device according to the comparative example. In the same manner as the image processing device according to the comparative example, the image processing device according to the embodiment of the present disclosure also functions mainly as a decoding device for decoding an input image. The image to be decoded by the image processing device according to the embodiment of the present disclosure may be a picked-up image, or may be a non-picked-up image such as a CG image. The image processing device according to the embodiment of the present disclosure may be any type of device such as a digital still camera, a smartphone, a PC, or an image scanner. Further, the image processing device according to the embodiment of the present disclosure may be an image decoding module mounted on the above-mentioned device.

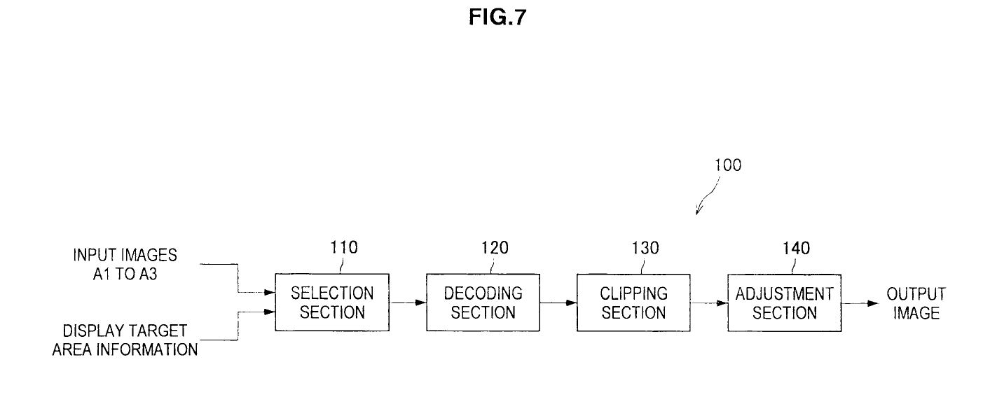

FIG. 7 is a block diagram showing an example of a configuration of an image processing device according to the embodiment of the present disclosure. Referring to FIG. 7, an image processing device 100 includes a selection section 110, a decoding section 120, a clipping section 130, and an adjustment section 140. Note that only the structural elements related to image processing are shown here for the sake of simple description. However, the image processing device 100 may have structural elements other than the structural elements shown in FIG. 7.

As shown in FIG. 7, the selection section 110 acquires input images A1 to A3, which are to be decoded, and display target area information, and selects any one of the input images A1 to A3 based on the ratio of the size of a display target area to the size of a reference image (any one of input images A1 to A3). Here, although the description will be made on the case where it is determined that the reference image is the input image A1, the reference image may also be an input image other than the input image A1 (for example, may also be the input image A2 or the input image A3). The reference image may be determined in advance, or may be determined by a user's selection.

The input images A1 to A3 each have resolution different from each other, and each have an image of same contents, for example. In the embodiment of the present disclosure, for the sake of simple description, the description of the following case will be made, where the resolution of the input image A2 is twice the resolution of the input image A1, and the resolution of the input image A3 is the twice the resolution of the input image A2, but the resolutions of multiple images are not limited to such an example. Note that the input images A1 to A3 are encoded by an encoding device (not shown), and the encoding system is not particularly limited, and may be variable length coding based on a Huffman code, a Golomb code, or the like, or may be entropy coding, for example. In the embodiment of the present disclosure, although three input images (input images A1 to A3) are acquired by the image processing device 100, the number of the input images acquired by the image processing device 100 is not limited to three, and may be any as long as it is two or more.

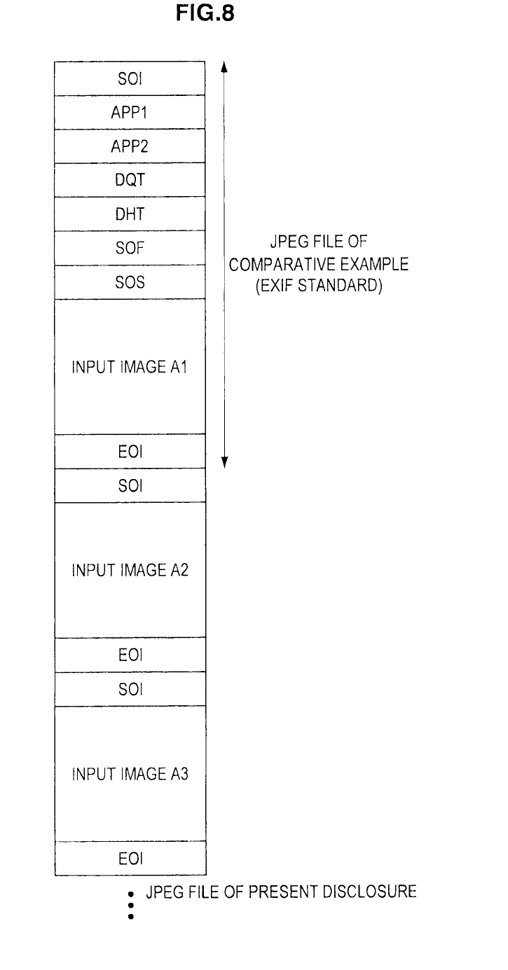

FIG. 8 is a diagram showing an example of a format of a file including the input images A1 to A3 decoded by the image processing device 100 according to the embodiment of the present disclosure. For example, although the input images A1 to A3 are given in a format included in the JPEG file shown in FIG. 8, it is not particularly limited as to a file in what format the input images A1 to A3 are given. However, as shown in FIG. 8, a format is adopted in which the input images A2 and A3 are added to rear parts of the JPEG file of the comparative example, and thus, the JPEG file according to the embodiment of the present disclosure can be handled while using an algorithm for handling the JPEG file of the comparative example. Note that the application of a multi picture format (MPO) file enables the JPEG file to have multiple images therein.

The selection section 110 acquires the display target area information in the way described above, for example. That is, the selection section 110 may acquire display target area information which accepts the input from a user using an input device, for example. Instead, the selection section 110 may acquire display target area information which is determined in advance from a recording medium (not shown) or the like.

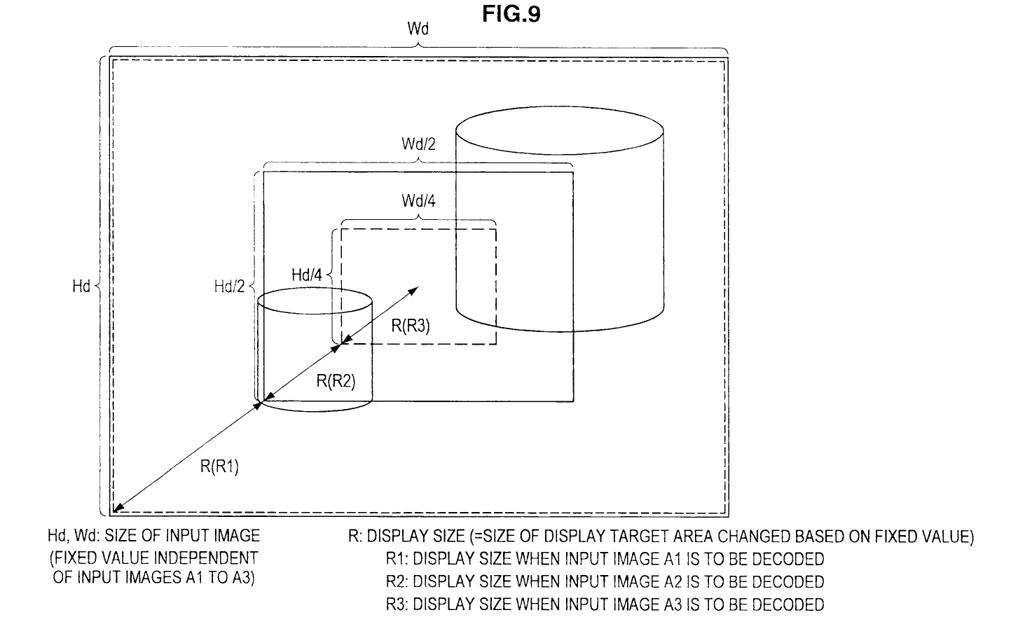

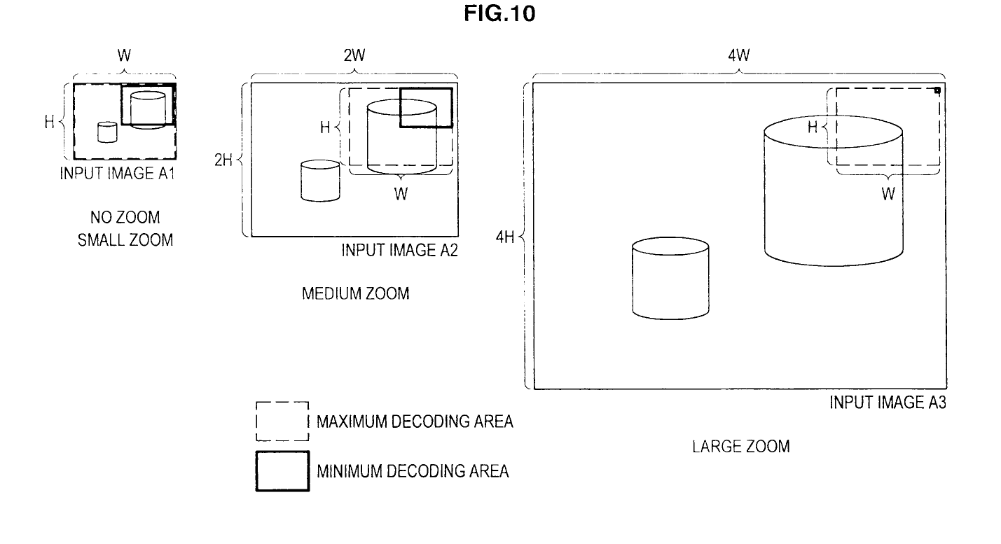

FIG. 9 and FIG. 10 are each a diagram illustrating functions of the selection section 110 and the decoding section 120 according to the embodiment of the present disclosure. FIG. 9 shows the widths and the heights of the respective input images A1 to A3 using a fixed value Hd and a fixed value Wd, which are independent of the sizes of the input images A1 to A3. Further, the size of the display target area (hereinafter, also referred to as “display size”) changed based on the fixed value (fixed value Hd) is represented by a display size R. In more detail, the display size R corresponds to R=h×(Hd/H). That is, the display size R represents an example of the ratio of the size of the display target area to the size of the reference image.

As described above, the selection section 110 selects any one of the input images A1 to A3 based on the ratio of the size of the display target area to the size of the reference image. In more detail, in the case where the input images A1 to A3 are associated with predetermined sizes (in the example of FIG. 9, there are shown height Hd, height Hd/2, and height Hd/4), respectively, the selection section 110 selects an image based on the relationship between the display size R and the predetermined size.

For example, in the case where the condition of “height Hd/2<display size R≦height Hd” is satisfied, the selection section 110 selects the input image A1, in the case where the condition of “height Hd/4<display size R<height Hd/2” is satisfied, the selection section 110 selects the input image A2, and in the case where the condition of “display size R<height Hd/4” is satisfied, the selection section 110 selects the input image A3.

In the case where the condition of “height Hd/2=display size R” is satisfied, the selection section 110 may select the input image A1 or the input image A2. Further, in the case where the condition of “height Hd/4=display size R” is satisfied, the selection section 110 may select the input image A2 or the input image A3.

Note that the selection section 110 may also perform the same processing by using width instead of height. That is, the display size R may be represented by the width of the display target area that is changed based on the fixed value (fixed value Wd), for example. In this case, the predetermined threshold may also be represented by a width (in the example of FIG. 9, there are shown width Wd, width Wd/2, and width Wd/4).

In FIG. 10, the widths and the heights of the input images A1 to A3 are represented by “width W, height H”, “width 2W, height 2H”, and “width 4W, height 4H”, respectively, which show actual sizes. As described above, the selection section 110 selects any one of the input images A1 to A3 based on the ratio of the size of the display target area to the size of the reference image. In more detail, in the case where the input images A1 to A3 are associated with predetermined thresholds (in the example shown in FIG. 10, (size of minimum decoding area)/(size of input image)=½, ¼, and 0), respectively, the selection section 110 selects an image based on the relationship between the ratio of the size (for example, height h) of the display target area to the size (for example, height H) of the reference image and those predetermined thresholds.

For example, in the case where the condition of “1≧ratio of the size of the display target area to the size of the reference image>½” is satisfied, the selection section 110 selects the input image A1, in the case where the condition of “½>ratio of the size of the display target area to the size of the reference image>¼” is satisfied, the selection section 110 selects the input image A2, and in the case where the condition of “¼>ratio of the size of the display target area to the size of the reference image>0” is satisfied, the selection section 110 selects the input image A3.

In the case where the condition of “½=ratio of the size of the display target area to the size of the reference image” is satisfied, the selection section 110 may select the input image A1 or the input image A2. In the case where the condition of “¼=ratio of the size of the display target area to the size of the reference image” is satisfied, the selection section 110 may select the input image A2 or the input image A3.

In the case where the input images A1 to A3 are associated with predetermined thresholds (in the example shown in FIG. 10, (size of maximum decoding area)/(size of input image)=1, ½, and ¼), respectively, the selection section 110 can also select in the same manner an image based on the relationship between the ratio of the size (for example, height h) of the display target area to the size (for example, height H) of the reference image and those predetermined thresholds.

Note that the selection section 110 may also perform the same processing using width instead of height. That is, the selection section 110 can also select in the same manner an image based on the relationship between the ratio of the size (for example, width w) of the display target area to the size (for example, width W) of the reference image and those predetermined thresholds.

The decoding section 120 acquires any one of the input images A1 to A3, which is to be decoded, and the display target area information, and decodes any one of the input images A1 to A3 based on the display target area information. In the case where the input image A1 is to be decoded, the decoding section 120 decodes a rectangular area defined by a height h and a width w on the basis of a reference point (x,y) within the input image A1, as the part corresponding to the display target area.

In the same manner, in the case where the input image A2 is to be decoded, the decoding section 120 decodes a rectangular area defined by a height 2h and a width 2w on the basis of a reference point reference point (2x,2y) within the input image A2, as the part corresponding to the display target area. In the case where the input image A3 is to be decoded, the decoding section 120 decodes a rectangular area defined by a height 4h and a width 4w on the basis of a reference point (4x,4y) within the input image A3, as the part corresponding to the display target area.

The input images A1 to A3 are encoded by an encoding device (not shown), and the encoding system is not particularly limited, and may be variable length coding (VLC) based on a Huffman code, a Golomb code, or the like, or may be entropy coding, for example. As a decoding technique performed by the decoding section 120, the same technique as the decoding technique performed by the decoding section 920 described in the comparative example can be adopted.

The clipping section 130 clips the decoding area from the image which is obtained by being decoded by the decoding section 120. In more detail, the clipping section 130 clips the area defined by the display target area information from the image which is obtained by being decoded by the decoding section 120. However, it is not necessary that the image processing device 100 be equipped with the clipping section 130, and the image processing device 100 may not be equipped with the clipping section 130.

In this way, the selection section 110 selects an image to be decoded, and hence, the decoding section 120 can keep the size of the decoding area equal to or less than the predetermined value (in the example shown in FIG. 10, height H×width W). Accordingly, the decoding can be smoothly performed regardless of the size and the position of the decoding area. Further, in the case of transferring an image of the part corresponding to the decoding area, the traffic thereof can be reduced.

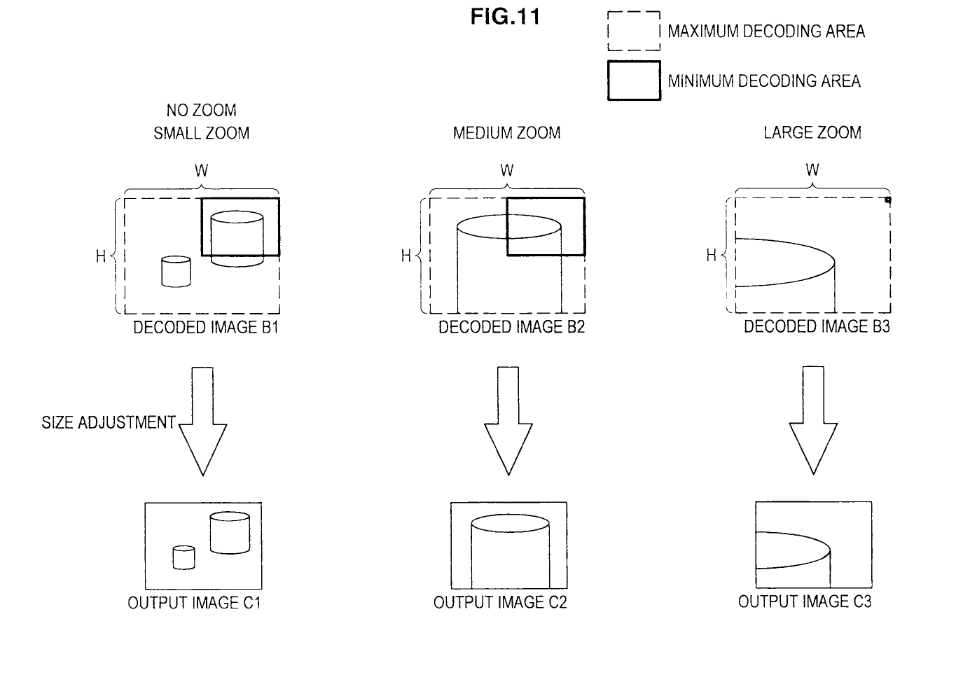

FIG. 11 is a diagram illustrating a function of the adjustment section 140 according to the embodiment of the present disclosure. As shown in FIG. 11, a decoded image B1 is obtained by decoding the input image A1. In the case where the input image A2 is decoded, a decoded image B2 is obtained, and in the case where the input image A3 is decoded, a decoded image B3 is obtained.

The adjustment section 140 adjusts the size of the part corresponding to the decoding area within the image which is obtained by being decoded by the decoding section 120. As shown in FIG. 11, the adjustment section 140 performs size adjustment (reduction) of the decoded image B1, thereby obtaining an output image C1. In the same manner, the adjustment section 140 performs size adjustment (reduction) of the decoded image B2, thereby obtaining an output image C2, and the adjustment section 140 performs size adjustment (reduction) of the decoded image B3, thereby obtaining an output image C3.

In this way, the size adjustment may be performed by enlarging or reducing, by the adjustment section 140, the part corresponding to the decoding area within the image which is obtained by being decoded by the decoding section 120. The technique of size adjustment performed by the adjustment section 140 is not particularly limited. For example, in the case where the output image output by the adjustment section 140 is displayed by a display device (not shown), the adjustment section 140 may adjust the size of the part corresponding to the display target area within the image which is obtained by the decoding, in accordance with the size of a display area of the display device (size of a screen of the display device).

Further, the adjustment section 140 may adjust the size of the part corresponding to the display target area within the image which is obtained by the decoding, depending on the degree according to the image selected by the selection section 110. In more detail, for example, the adjustment section 140 can perform the size adjustment by multiplying the part corresponding to the display target area within the image which is obtained by the decoding by an enlargement ratio such as α1 in the case where the input image A1 is selected, α2 in the case where the input image A2 is selected, and a3 in the case where the input image A3 is selected.

### 2-2. Flow of Operation Performed by Image Processing Device

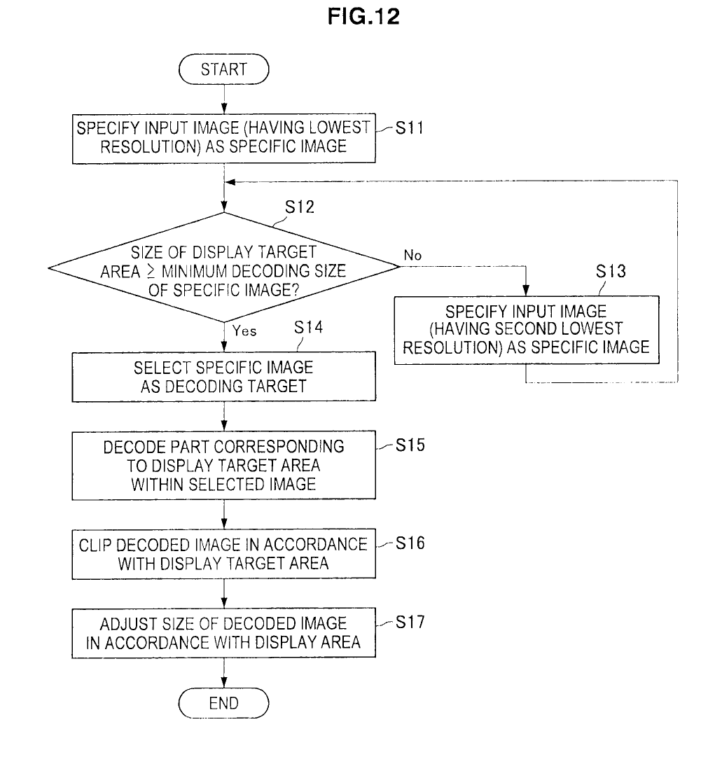

FIG. 12 is a flowchart showing an example of an operation of the image processing device 100 according to the embodiment of the present disclosure. First, the selection section 110 specifies an input image (for example, input image A1 having the lowest resolution) as a specific image (Step S11). The selection section 110 determines whether or not the size of a display target area is equal to or more than a minimum decoding size of the specific image (size of minimum decoding area of specific image) (Step S12).

In the case where the size of the display target area is less than the minimum decoding size of the specific image (size of minimum decoding area of specific image) (“No” in Step S12), the selection section 110 re-specifies an input image (input image having the second lowest resolution next to the specific image) as the specific image (Step S13), and returns to Step S12. On the other hand, in the case where the size of the display target area is equal to or more than the minimum decoding size of the specific image (size of minimum decoding area of specific image) (“Yes” in Step S12), the selection section 110 selects the specific image as a decoding target (Step S14).

The decoding section 120 decodes the part corresponding to the display target area within the image selected by the selection section 110 (Step S15). The clipping section 130 clips a decoded image in accordance with the display target area from the image obtained by the decoding (Step S16). However, the clipping by the clipping section 130 may not be performed in particular. Subsequently, the adjustment section 140 adjusts the size of the decoded image in accordance with the display area (Step S17), and completes the operation.

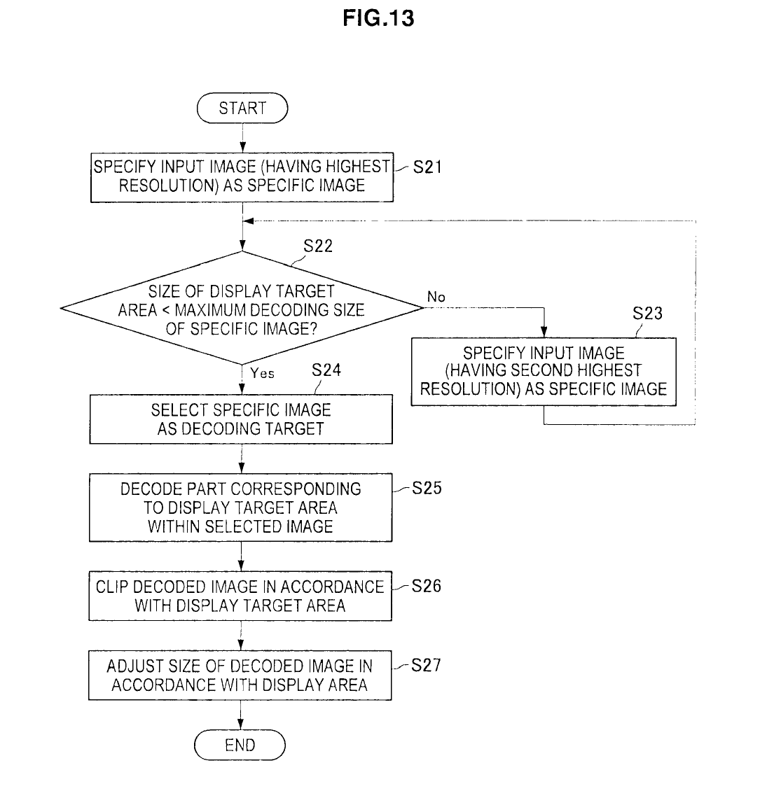

FIG. 13 is a flowchart showing another example of the operation of the image processing device 100 according to the embodiment of the present disclosure. First, the selection section 110 specifies an input image (for example, input image A3 having the highest resolution) as a specific image (Step S21). The selection section 110 determines whether or not the size of a display target area is less than a maximum decoding size of the specific image (size of maximum decoding area of specific image) (Step S22).

In the case where the size of the display target area is equal to or more than the maximum decoding size of the specific image (size of maximum decoding area of specific image) (“No” in Step S22), the selection section 110 re-specifies an input image (input image having the second highest resolution next to the specific image) as the specific image (Step S23), and returns to Step S22. On the other hand, in the case where the size of the display target area is less than the maximum decoding size of the specific image (size of maximum decoding area of specific image) (“Yes” in Step S22), the selection section 110 selects the specific image as a decoding target (Step S24).

The decoding section 120 decodes the part corresponding to the display target area within the image selected by the selection section 110 (Step S25). The clipping section 130 clips a decoded image in accordance with the display target area from the image obtained by the decoding (Step S26). However, the clipping by the clipping section 130 may not be performed in particular. Subsequently, the adjustment section 140 adjusts the size of the decoded image in accordance with the display area (Step S27), and completes the operation.

### 3. CONCLUSION

According to the embodiment described in the present disclosure, an image to be decoded is selected from multiple images each having resolution different from each other, and decoding processing is performed to the selected image. Accordingly, even when the size of the display target area is changed, the throughput necessary for the decoding can be kept equal to or less than a predetermined value at all times. Therefore, the part corresponding to the display target area within the encoded image can be displayed quickly regardless of the size of the display target area. In addition, in the case of transferring an image of the part corresponding to the decoding area, the traffic thereof can be reduced.

Note that a series of control processing performed by each device described in this specification may be realized by using any of software, hardware, and combination of software and hardware. A program for configuring the software is stored in a computer-readable recording medium which is internally or externally provided to each device, for example. Then, each program is loaded on a RAM (Random Access Memory) at the time of the execution thereof and is executed by a processor such as a CPU (Central Processing Unit), for example.

It should be understood by those skilled in the art that various modifications, combinations, sub-combinations and alterations may occur depending on design requirements and other factors insofar as they are within the scope of the appended claims or the equivalents thereof.

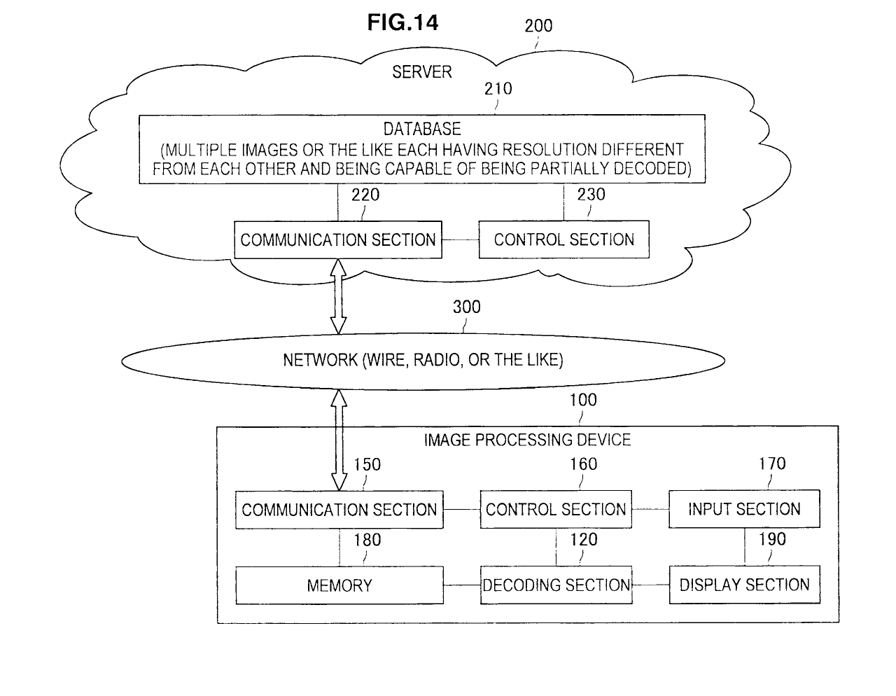

Note that, in the present embodiment, the image processing device 100 acquires the input image, and includes the selection section 110, the decoding section 120, the clipping section 130, and the adjustment section 140, but all the functions thereof may not necessarily be performed by the image processing device 100. For example, a part of those functions may be performed by a server. FIG. 14 is a diagram showing an outline of a system configuration in the case where an image processing device 100 and a server 200 perform image processing in cooperation with each other. As shown in FIG. 14, the image processing device 100 and the server 200 are capable of communicating with each other via a network 300. The server 200 can hold multiple images (for example, input images A1 to A3) each having resolution different from each other and being capable of being partially decoded, as a database 210. The server 200 includes a communication section 220 which communicates with image processing device 100 via the network 300, the database 210, a control section 230 which controls the communication section 220, and the like. The network 300 is configured by wire or radio.

The image processing device 100 includes a communication section 150 which communicates with the server 200 via the network 300, an input section 170 which accepts an input of operation from a user, a control section 160 which controls operation of the image processing device 100, a memory 180 which is used for the control performed by the image processing device 100, the decoding section 120 described above, a display section 190 which displays an output image, and the like.

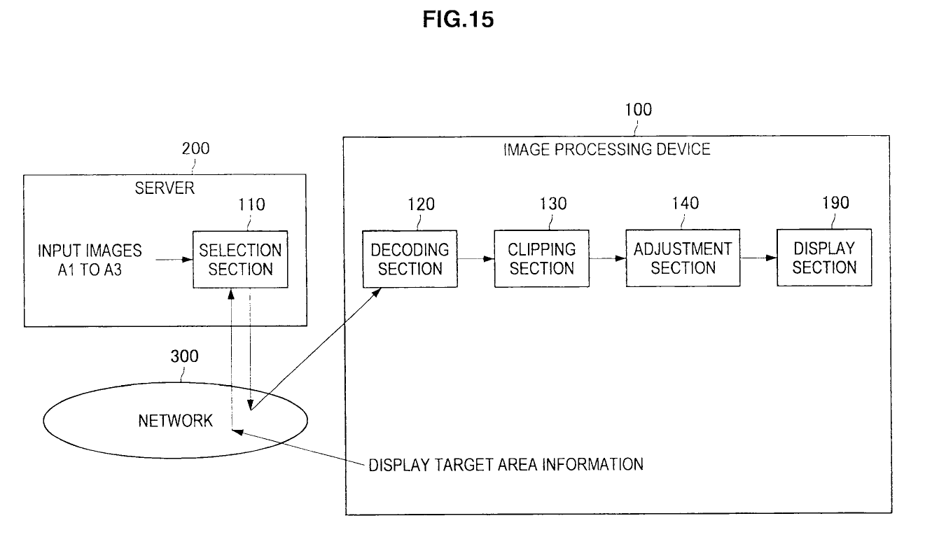

FIG. 15 is a diagram showing a specific example 1 of the system configuration diagram described above. As shown in FIG. 15, the image processing device 100 transmits display target area information to the server 200 via the network 300, and the server 200 receives the display target area information. The selection section 110 included in the server 200 selects an image based on multiple images (for example, input images A1 to A3) and the received display target area information. In this case, as shown in FIG. 15, the server 200 may transmit the selected image to the image processing device 100 via the network 300. Further, as shown in FIG. 15, the decoding processing performed by the decoding section 120, the clipping processing performed by the clipping section 130, the size adjustment performed by the adjustment section 140, and the like may be carried out in the image processing device 100.

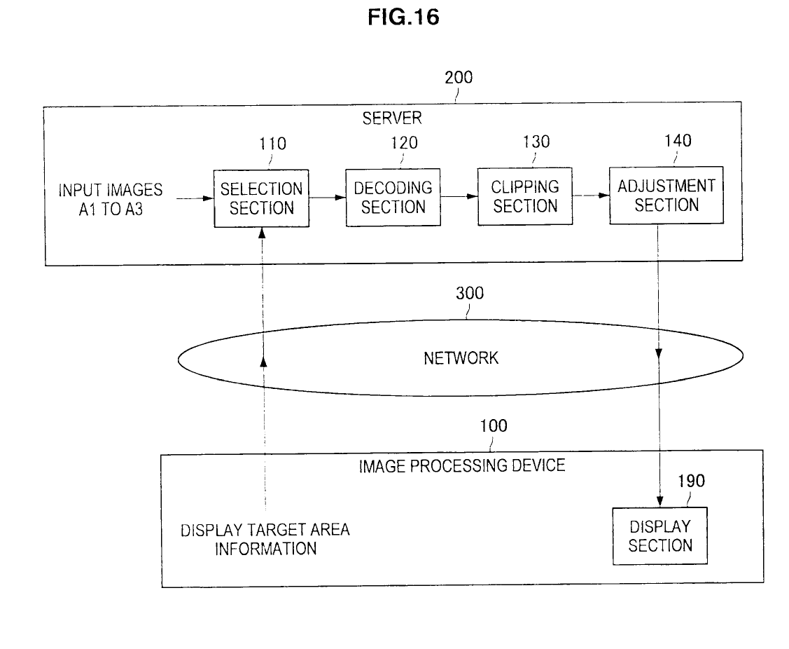

FIG. 16 is a diagram showing a specific example 2 of the system configuration diagram described above. As shown in FIG. 16, in the same manner as the specific example 1 shown in FIG. 15, the selection section 110 included in the server 200 selects an image based on multiple images (for example, input images A1 to A3) and the received display target area information. In this case, as shown in FIG. 16, the decoding processing performed by the decoding section 120, the clipping processing performed by the clipping section 130, the size adjustment performed by the adjustment section 140, and the like may be carried out in the server 200, and the server 200 may transmit an output image to the image processing device 100 via the network 300. The decoding processing performed by the decoding section 120 may also be carried out in the image processing device 100.

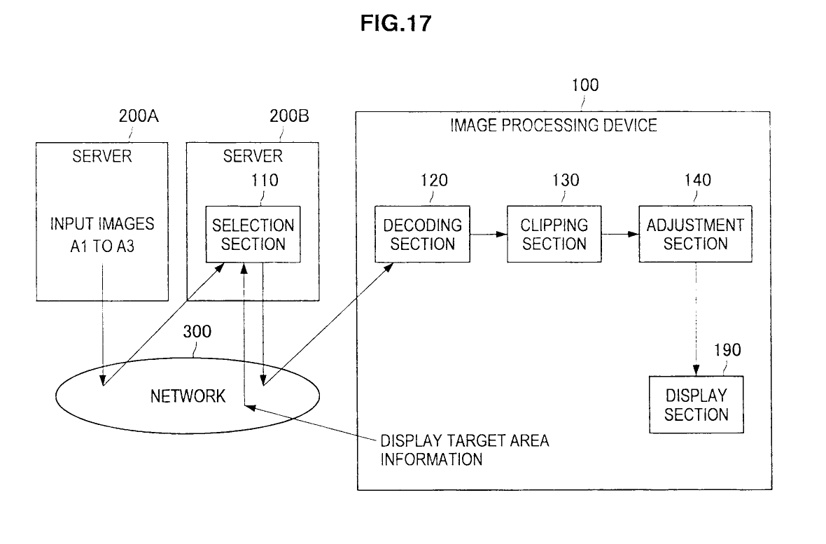

FIG. 17 is a diagram showing a specific example 3 of the system configuration diagram described above. As shown in FIG. 17, in the same manner as the specific example 1 shown in FIG. 15, the selection section 110 included in a server 200B selects an image based on multiple images (for example, input images A1 to A3) and the received display target area information. In this case, as shown in FIG. 17, the server 200B which selects the image and a server 200A which holds multiple images (for example, input images A1 to A3) may be configured separately. That is, the server 200B may acquire multiple images (for example, input images A1 to A3) from the server 200A.

Additionally, the present technology may also be configured as below.

(1) An image processing device including:
a selection section which selects an image from a plurality of images each having resolution different from each other and being capable of being partially decoded, based on a ratio of a size of a display target area to a size of a reference image among the plurality of images; and
a decoding section which decodes a part corresponding to the display target area within the image selected by the selection section.
   (2) The image processing device according to (1),
wherein the plurality of images are associated with respective predetermined thresholds, and
wherein the selection section selects the image based on a relationship between the ratio of the size of the display target area to the size of the reference image and the predetermined thresholds associated with the respective plurality of images.
   (3) The image processing device according to (1) or (2), further including:
an adjustment section which adjusts a size of a part corresponding to the display target area decoded by the decoding section within the image selected by the selection section.
   (4) The image processing device according to (3),
wherein the adjustment section adjusts the size of the part corresponding to the display target area decoded by the decoding section within the image selected by the selection section, in accordance with a size of a display area.
   (5) The image processing device according to (3),
wherein the adjustment section adjusts the size of the part corresponding to the display target area decoded by the decoding section within the image selected by the selection section, depending on a degree according to the image selected by the selection section.
   (6) The image processing device according to any one of (1) to (5), further including:
a clipping section which clips the display target area from the image selected by the selection section.
   (7) An image processing method including:
selecting an image from a plurality of images each having resolution different from each other and being capable of being partially decoded, based on a ratio of a size of a display target area to a size of a reference image among the plurality of images; and
decoding a part corresponding to the display target area within the selected image.
   (8) A program for causing a computer to function as an image processing device including
a selection section which selects an image from a plurality of images each having resolution different from each other and being capable of being partially decoded, based on a ratio of a size of a display target area to a size of a reference image among the plurality of images, and
a decoding section which decodes a part corresponding to the display target area within the image selected by the selection section.

The present disclosure contains subject matter related to that disclosed in Japanese Priority Patent Application JP 2011-120239 filed in the Japan Patent Office on May 30, 2011, the entire content of which is hereby incorporated by reference.

What is claimed is:

1. An image processing device comprising:
a selection section which selects an image from a plurality of images each having resolution different from each other and being capable of being partially decoded, based on a ratio of a size of a display target area to a size of a reference image among the plurality of images; and
a decoding section which decodes a part corresponding to the display target area within the image selected by the selection section.

2. The image processing device according to claim 1,
wherein the plurality of images are associated with respective predetermined thresholds, and
wherein the selection section selects the image based on a relationship between the ratio of the size of the display target area to the size of the reference image and the predetermined thresholds associated with the respective plurality of images.

3. The image processing device according to claim 1, further comprising:
an adjustment section which adjusts a size of a part corresponding to the display target area decoded by the decoding section within the image selected by the selection section.

4. The image processing device according to claim 3,
wherein the adjustment section adjusts the size of the part corresponding to the display target area decoded by the decoding section within the image selected by the selection section, in accordance with a size of a display area.

5. The image processing device according to claim 3,
wherein the adjustment section adjusts the size of the part corresponding to the display target area decoded by the decoding section within the image selected by the selection section, depending on a degree according to the image selected by the selection section.

6. The image processing device according to claim 1, further comprising:
a clipping section which clips the display target area from the image selected by the selection section.

7. An image processing method comprising:
selecting an image from a plurality of images each having resolution different from each other and being capable of being partially decoded, based on a ratio of a size of a display target area to a size of a reference image among the plurality of images; and
decoding a part corresponding to the display target area within the selected image.

8. A program for causing a computer to function as an image processing device including
a selection section which selects an image from a plurality of images each having resolution different from each other and being capable of being partially decoded, based on a ratio of a size of a display target area to a size of a reference image among the plurality of images, and
a decoding section which decodes a part corresponding to the display target area within the image selected by the selection section.
